(19) United States
(12) Patent Application Publication
(10) Pub. No.: US 2008/0270270 A1
(43) Pub. Date: Oct. 30, 2008

(54) System and method for monitoring and management of inventory of products and assets in real time

(76) Inventors: Girish A. Ramachandra, Bangalore (IN); Vibin Balakrishnan, Shoranur (IN); Shashi Shekhar Vempati, Hyderabad (IN)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 11/975,913

(22) Filed: Oct. 22, 2007

(30) Foreign Application Priority Data
Oct. 25, 2006 (IN) 1955/CHE/2006

(51) Int. Cl. G06Q 10/00

(52) U.S. Cl. 705/28

(57) ABSTRACT

A system for real time monitoring and management of an inventory of products and assets includes one or more smart storage units, each comprising a storage unit for housing inventory products and assets, coupled with a general purpose interface board (GPIB) for automatic detection and communication of one or more inventory events. A central server is coupled with at least one smart storage unit, and comprises an aggregation module for aggregating the inventory events received from at least one smart storage unit, an analysis module for processing the aggregated inventory events for producing inventory tracking reports, and a communication module for communicating at least one of the inventory events and the inventory tracking reports. One or more destination devices are coupled with the central server for displaying at least one of the received inventory events and the inventory tracking reports.

### BACKGROUND OF THE INVENTION

The present invention is directed towards providing real time monitoring and management of products and assets stored at geographically spread locations. More particularly, the present invention provides a system and method for monitoring and managing inventory products and assets from remote locations, by using a plurality of automatic identification, and remote processing and communication devices and methods.

The use of sensors and automatic identification and data capturing (AIDC) devices and methods for inventory management is becoming more prevalent with the rapid growth in economy. AIDC devices and methods comprise barcode readers, detection by using radio frequency identification (RFID) tags, etc. Sensors include devices that measure changes in environmental parameters such as magnetic field, weight, temperature, light etc. for detection of the presence or absence of products. An increase in the number of products and assets being provided at a point of consumption such as a retail outlet has led to use of various inventory management processes.

Most of the currently available inventory management processes acquire inventory data either manually or by using existing sensor and AIDC devices and methods, and then process the acquired data by transferring it to an off line central processing system. Such inventory management processes suffer from latency introduced between occurrence of an inventory event, such as number of products available at a point of consumption falling below a predetermined threshold value, and transfer of the inventory event to the central processing system. In cases where the inventory products are of high value and have very short shelf lives such as, medical or surgical products and devices, the latency in transfer of inventory events to the central processing system may lead to a loss to suppliers, who supply the products at points of consumptions, such as hospitals, on a consignment basis.

Further, where an inventory management process collects inventory data using manual means in full or in part, the process is susceptible to inaccuracies arising from mistakes made by people engaged in collecting inventory data. Also, in case inventory products require a sterile environment, accessibility to storage areas may be difficult.

Consequently, there is need for a system and a method for monitoring and managing geographically spread products and assets that use sensing and automatic identification devices and methods, define business rules, and communicate inventory events on a real time basis to a plurality of destinations. Real time communication of inventory events would enable users to improve planning for replenishing inventories by providing real time visibility of inventory products or assets at points of consumption. The improved planning for replenishment of inventories would further lead to decrease in losses incurred due to product obsolescence and stock-outs, suffered on account of delay between occurrence of an inventory event and its communication.

### SUMMARY OF THE INVENTION

A system for real time monitoring and management of an inventory of products and assets is provided. The system comprises one or more smart storage units, each smart storage unit comprising a storage unit for housing inventory products and assets, coupled with a general purpose interface board (GPIB) for automatic detection and communication of one or more inventory events; a central server coupled with at least one smart storage unit, comprising an aggregation module for aggregating the inventory events received from at least one smart storage unit, an analysis module for processing the aggregated inventory events for producing inventory tracking reports, and a communication module for communicating at least one of the inventory events and the inventory tracking reports; and one or more destination devices coupled with the central server for displaying at least one of the received inventory events and the inventory tracking reports.

In an embodiment of the present invention, the inventory products and assets are provided with means enabling their automatic detection and the GPIB detects inventory events using sensors. In an embodiment of the present invention, the destination devices comprise at least one of computing devices and display devices such as ERP systems, handheld computing devices such as PDAs, communication devices such as mobile phones, etc.

The GPIB comprises an AIDC and sensor module for automatic detection of one or more inventory events for detecting presence or absence of inventory products and assets in the storage unit; a processor for determining if one or more of the detected inventory events require to be communicated, by using business logic stored in a memory module as embedded software; a communication interface for communicating one or more of the inventory events that require to be communicated; and communication buses coupling the AIDC and sensor module with the processor and the processor with the communication interface. The communication interface supports one or more of communication standards such as RS232, Ethernet, USB etc and comprises a communication gateway, such as a GPRS modem, that couples the GPIB with one or more destinations devices such as ERP systems, handheld computing devices such as PDAs, and communication devices such as mobile phones, etc.

A method for real time monitoring and management of an inventory of products and assets is also provided. The method comprises the steps of obtaining inventory events; determining whether the obtained inventory events require to be notified; notifying the inventory events that require to be notified; repeating steps a. and b. if none of the obtained inventory events require to be notified; aggregating the notified inventory events; analyzing the aggregated inventory events; and communicating the analyzed inventory events to one or more destinations. The inventory events comprise one or more of events such as, number of products in the inventory decreasing below a predetermined threshold value, and a difference between current date and expiry dates of products in the inventory decreasing below a predetermined threshold value. The inventory events are obtained by using at least one of sensors and AIDC devices and methods.

The step of determining whether the obtained inventory events require to be notified is performed by processing the obtained inventory events by using business logic comprising at least one notification criterion and the step of notification of an inventory event is performed in real time. In an embodiment of the present invention, the step of notification of an inventory event comprises communication of said inventory event to a predetermined destination for further processing and the step of aggregation of the notified events is performed periodically at predefined intervals of time. The step of analyzing inventory events comprises processing the aggregated inventory events to produce inventory tracking reports, by using one or more of historical inventory data and data obtained from external sources. In an embodiment of the present invention, the destination comprises an interactive voice response (IVR) system, a user obtaining information regarding notified events by dialing into the IVR system.

### BRIEF DESCRIPTION OF THE DRAWINGS

The present invention is described by way of embodiments illustrated in the accompanying drawings wherein:

FIG. 1 is a block diagram depicting a system for monitoring and managing inventory events from remote locations;

FIG. 2 is a block diagram depicting a general purpose interface board (GPIB); and

FIG. 3 is a flowchart illustrating a method for monitoring and managing inventory events from remote locations.

### DETAILED DESCRIPTION

A system and a method monitoring and managing inventory events from remote locations, by using a plurality of sensors and automatic identification, remote processing and communication devices and methods, are described herein. The method of the invention may be provided on a computer readable medium.

The following disclosure is provided in order to enable a person having ordinary skill in the art to practice the invention. Exemplary embodiments are provided only for illustrative purposes and various modifications will be readily apparent to persons skilled in the art. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

The present invention would now be discussed in context of embodiments as illustrated in the accompanying drawings.

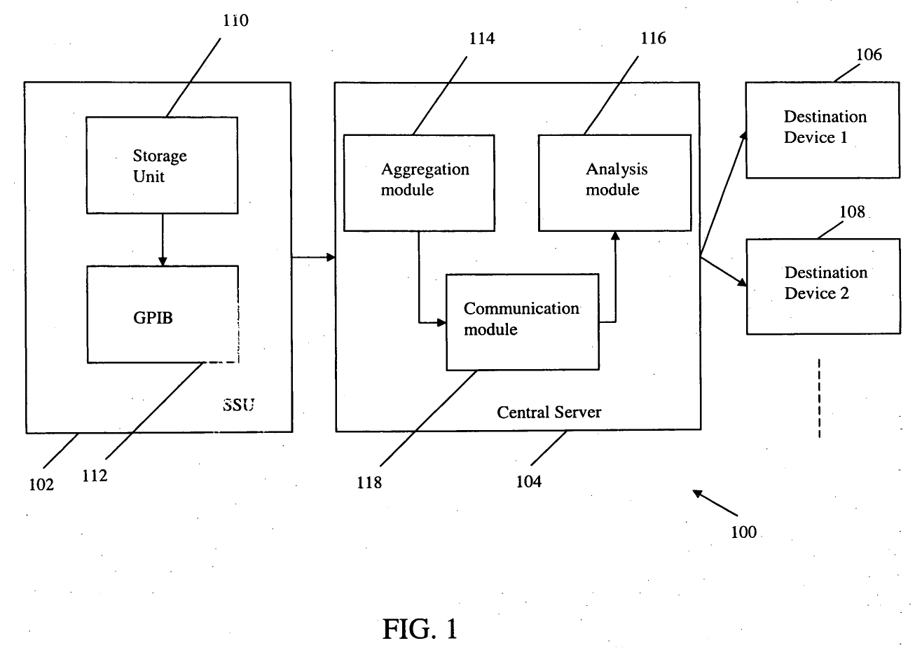

FIG. 1 is a block diagram depicting a system for monitoring and managing inventory events from remote locations. System 100 comprises a smart storage unit (SSU) 102, a central server 104 and a plurality of communication devices 106, 108.

SSU 102 comprises a storage unit 110 and a general purpose interface board (GPIB) 112. Storage unit 110 houses inventory products and assets. The products and assets may be provided with means enabling their automatic detection, such as barcodes, magnetic strips, RFID tags, etc. Storage unit 110 is coupled with GPIB 112 which comprises a module for automatic detection of inventory events, an edge processor for processing the detected inventory events by using business rules and a modem for communicating one or more of the inventory events to central server 104. Examples of inventory events may comprise events such as, number of products in storage unit 110 decreasing below a predetermined threshold value, or difference between current date and expiry dates of products in storage unit 110 decreasing below a predetermined threshold value.

In an embodiment of the present invention, wherein a plurality of SSUs 102 are present within a predefined geographical vicinity, each of the SSUs 102 is provided with communication means for communicating their inventory events to each other, and only one of the plurality of SSUs 102 is provided with means for communicating one or more of the inventory events to central server 104. In such an embodiment of the present invention only one modem is provided for communicating one or more of the inventory events to central server 104 corresponding to a plurality of SSUs 102 within a predefined geographical vicinity. In an exemplary scenario, only one out of ten SSUs, provided in a store for housing and displaying predefined product, acts as a gateway and is fitted with a modem for communicating inventory events to a central server. Further, the ten SSUs are enabled for communicating among themselves by using any of the standard communication protocols such as ZigBee®. Hence, an inventory event occurring at a first SSU may be communicated via ZigBee® to a second SSU and so on till the inventory event reaches the gateway SSU which further communicates the event to a central server via the provided modem.

Central server 104 comprises an aggregation module 114, an analysis module 116 and a communication module 118. Aggregation module 114 aggregates the inventory events received from GPIB 112. Analysis module 116 processes the received inventory events to produce inventory tracking reports. In an embodiment of the present invention, historical inventory data as well as data obtained from external sources is used for producing the inventory tracking reports. For example, in an embodiment of the present invention, demographic data is used with obtained inventory events and historical inventory data to obtain reports providing information regarding consumption of one or more of the inventory products in different geographical areas. In various embodiments of the present invention, central server 104 may be implemented on any commercially available server platforms such as Windows, Linux, etc.

Communication module 118 publishes information related to the inventory events as well as the inventory tracking reports to one or more of the destination devices 106 and 108. In various embodiments of the present invention, the information may be published as an XML message to ERP systems, or sent as alerts on a handheld device such as PDA or mobile phones. For example, information such as a list of products expiring within the next two weeks may be made available on destination devices such as a PDA or a BlackBerry® device or, information such as an outstanding demand for a specific product may be sent as an alert message to a mobile phone.

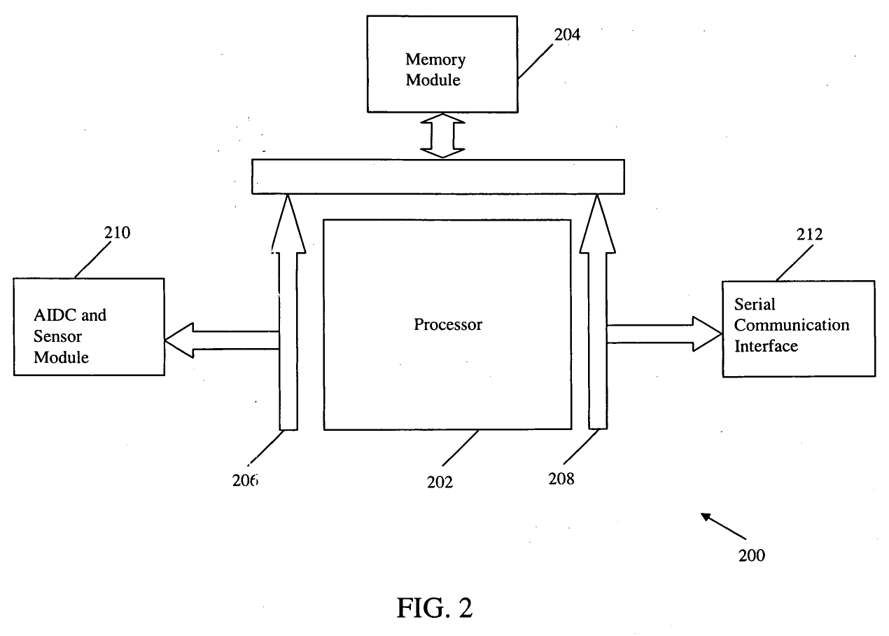

FIG. 2 is a block diagram depicting a general purpose interface board (GPIB) 200. GPIB 200 comprises a processor 202, a memory module 204, communication bus 206 and 208, an AIDC and sensor module 210, and a communication interface module 212.

In an embodiment of the present invention, GPIB 200 is a hardware platform that integrates sensors and devices used for AIDC with communication interfaces such as GSM, GPRS, USB, Wifi and Ethernet. Processor 202 is implemented as an edge processor, and processes firmware comprising business logic stored in memory module 204. In an embodiment of the present invention, memory module 204 comprises Flash memory and DRAM memory.

Communication bus 206 is coupled to various sensors and AIDC devices via suitable interfaces. AIDC and sensor module 210 comprises devices for automatic detection of products or assets such as RFID readers, bar code scanners, magnetic strip readers, and other sensing elements such as load cells, thermostats etc. AIDC and sensor module 210 is coupled to communication bus 206 via a serial communication port such as RS232. In an embodiment of the present invention, AIDC and sensor module 210 comprises an ISO 15693 compliant HF RFID reader with an antenna. The products or assets provided with RFID tags are detected by the antenna when they are in its field. In another embodiment of the present invention, AIDC and sensor module 210 comprises a sensing element like a magnetic limit switch for detecting presence or absence of products on a retail store display shelf, thus identifying out of stock events without relying on any identification mechanisms like RFID tags or barcodes provided on the products. As would be apparent to a person of skill in the art, in various embodiments of the present invention, communication bus 206 may be coupled with various other devices for automatically obtaining status of inventory products or assets via corresponding interfaces.

Communication bus 208 is coupled to various communication devices via suitable communication interfaces. In an embodiment of the present invention, communication interface module 212 supports one or more of communication standards such as RS232, Ethernet, USB etc. for coupling communication bus 208 with various communication devices. In an embodiment of the present invention, communication interface module 212 comprises a communication gateway such as a GSM/GPRS modem that couples communication bus 208 with various destination devices such as ERP systems and communication devices, such as mobile phones, PDAs etc.

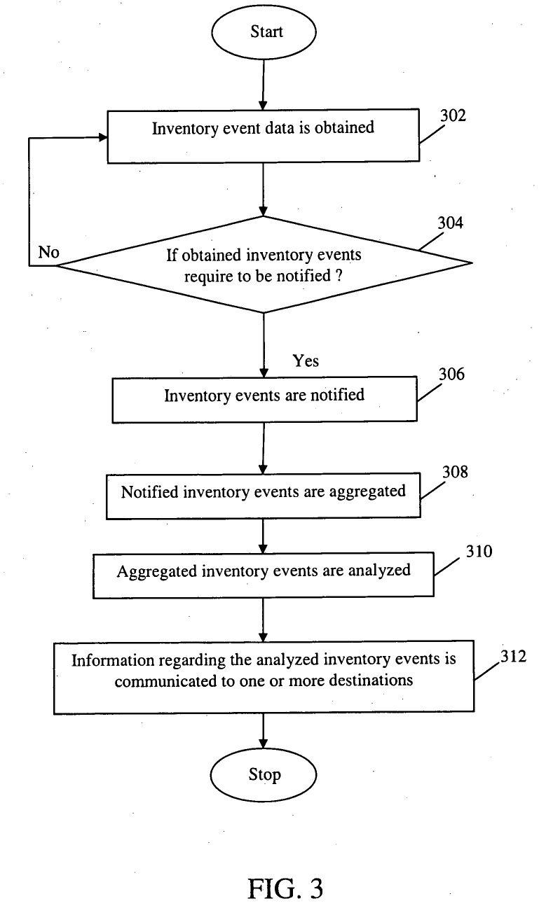

FIG. 3 is a flowchart illustrating a method for monitoring and managing inventory events from remote locations. At step 302, inventory event data is obtained. Examples of inventory events may comprise events such as, number of products in the inventory decreasing below a predetermined threshold value, difference between currents date and expiry dates of products in the inventory decreasing below a predetermined threshold value etc. In an exemplary embodiment of the present invention, an inventory being monitored and managed comprises medical products of high value and short shelf lives. The medical products are provided with radio frequency identification (RFID) tags. The RFID tags on the product packaging are sensed by an antenna connected to an RFID reader module and are provided for processing.

At step 304, it is determined whether the obtained inventory events require to be notified. In an embodiment of the present invention, obtained inventory events are processed using business logic, in order to obtain the inventory events that qualify a notification criterion, and require to be notified. Notification criteria may be predetermined and incorporated into the business logic. For example, the business logic may comprise conditions such as: ‘if number of products in inventory <2, then notify’. A plurality of notification criteria may also be applied to ascertain whether the obtained inventory events require to be notified. Processing of inventory events may take place periodically, at predetermined time intervals or in real time whenever an inventory event is obtained.

If one or more of the obtained inventory events require to be notified at step 304, said inventory events are notified at step 306. If none of the obtained inventory events require to be notified, step 302 is repeated. In an embodiment of the present invention, notification of an inventory event comprises communication of said inventory event to a predetermined destination such as a central server for further processing. Notification of inventory events may take place periodically, at predetermined time intervals or in real time whenever an inventory event is obtained.

At step 308, the notified inventory events are aggregated. In an embodiment of the present invention, aggregation of inventory events may comprise collection of inventory events corresponding to a particular type of product obtained from a plurality of geographically spread locations. In other embodiments, various other aggregation rules may be applied to aggregate the notified inventory events. Aggregation of inventory events may take place periodically, at predetermined time intervals.

At step 310, the aggregated inventory events are analyzed. In an embodiment of the present invention, analysis of inventory events may comprise processing the aggregated inventory events to produce inventory tracking reports. In an embodiment of the present invention, historical inventory data as well as data obtained from external sources may be used for producing reports. For example, demographic data may be used with aggregated inventory events and historical inventory data to publish reports providing information regarding consumption of one or more of the inventory products in different geographical areas.

At step 312, information regarding the analyzed inventory events is communicated to one or more destinations. Examples of the destinations comprise secure internet sites over which inventory tracking reports may be browsed, mobile devices such as BlackBerry® devices, PDAs or mobile phones on which information may be transferred by using short messaging service (SMS). In an embodiment of the present invention, users located at geographically spread locations may send an SMS requesting desired information at a predetermined number and have the information delivered as an SMS response on their mobile devices. In another embodiment of the present invention, users located at geographically spread locations may dial a predetermined number and are responded to by an interactive voice response (IVR) system. The users are requested to enter information, such as a predetermined ID of a geographical location they are seeking information about. In response to the information entered by the users, the IVR system provides the desired information.

Therefore the present invention provides a system, a method and a computer program product for monitoring and managing geographically spread products and assets by leveraging convergence of sensors, automatic identification, remote processing and communication devices and methods. The system and method of the present invention may be employed while monitoring and managing inventories comprising high value, low shelf life products and assets, that are present at geographically spread locations. The present invention enables users to improve planning for replenishing inventories by providing real time visibility of inventory products or assets at points of consumption.

The system and method of the present invention enable monitoring inventory events, making business sense of the same immediately and communicating the events on a real time basis to a plurality of destinations, such as central processing systems, e-mailboxes, text messages on cell phones, etc. Therefore, the present invention enhances relevance and reliability of information which is valuable in the planning and replenishment processes corresponding to an inventory. Further, the use of a general purpose interface board enables a choice of multiple AIDC and sensor devices and methods such as RFID, load sensors, etc., as well as communication devices and methods such as Wi-Fi, GSM/GPRS, Wi-Max, Bluetooth etc.

While the present invention has been shown and described with reference to exemplary embodiments, it will be understood by those skilled in the art that various changes in form and detail may be made therein without departing from or offending the spirit and scope of the invention.

We claim:

1. A system for real time monitoring and management of an inventory of products and assets, the system comprising:
a. one or more smart storage units, each smart storage unit comprising a storage unit for housing inventory products and assets, coupled with a general purpose interface board (GPIB) for automatic detection and communication of one or more inventory events;
b. a central server coupled with at least one smart storage unit, comprising an aggregation module for aggregating the inventory events received from at least one smart storage unit, an analysis module for processing the aggregated inventory events for producing inventory tracking reports, and a communication module for communicating at least one of the inventory events and the inventory tracking reports; and
c. one or more destination devices coupled with the central server for displaying at least one of the received inventory events and the inventory tracking reports.

2. A system as claimed in claim 1, wherein the inventory products and assets are provided with means enabling their automatic detection.

3. A system as claimed in claim 1, wherein the GPIB detects inventory events using sensors.

4. A system as claimed in claim 1, wherein the destination devices comprise at least one of computing devices and display devices such as ERP systems, handheld computing devices such as PDAs, communication devices such as mobile phones, etc.

5. A system as claimed in claim 1, wherein the GPIB comprises:
a. an AIDC and sensor module for automatic detection of one or more inventory events for detecting presence or absence of inventory products and assets in the storage unit;
b. a processor for determining if one or more of the detected inventory events require to be communicated, by using business logic stored in a memory module;
c. a communication interface for communicating one or more of the inventory events that require to be communicated; and
d. communication buses coupling the AIDC and sensor module with the processor and the processor with the communication interface.

6. A system as claimed in claim 1, wherein the communication interface supports one or more of communication standards such as RS232, Ethernet, USB etc.

7. A system as claimed in claim 1, wherein the communication interface comprises a communication gateway that couples the GPIB with one or more destination devices.

8. A method for real time monitoring and management of an inventory of products and assets, the method comprising:
a. obtaining inventory events;
b. determining whether the obtained inventory events require to be notified;
c. notifying the inventory events that require to be notified;
d. repeating steps a. and b. if none of the obtained inventory events require to be notified;
e. aggregating the notified inventory events;
f. analyzing the aggregated inventory events; and
g. communicating the analyzed inventory events to one or more destinations.

9. The method as claimed in claim 8, wherein the inventory events comprise one or more of events of number of products in the inventory decreasing below a predetermined threshold value, and a difference between current date and expiry dates of products in the inventory decreasing below a predetermined threshold value.

10. The method as claimed in claim 8, wherein the inventory events are obtained by using at least one of sensors and AIDC devices and methods.

11. The method as claimed in claim 8, wherein determining whether the obtained inventory events require to be notified is performed by processing the obtained inventory events by using business logic comprising at least one notification criterion.

12. The method as claimed in claim 8, wherein the notification of an inventory event is performed in real time.

13. The method as claimed in claim 8, wherein the notification of an inventory event comprises communication of said inventory event to a predetermined destination for further processing.

14. The method as claimed in claim 8, wherein the aggregation of the notified events is performed periodically at predefined intervals of time.

15. The method as claimed in claim 8, wherein the analyzing inventory events comprises processing the aggregated inventory events to produce inventory tracking reports, by using one or more of historical inventory data and data obtained from external sources.

16. The method as claimed in claim 8, wherein the destinations comprise secure internet sites over which inventory tracking reports are browsed by mobile devices to which information is transferred by using short messaging service (SMS).

17. The method of claim 16, wherein the mobile devices comprise one of a smart phone, BlackBerry® device, PDA or mobile phone.

18. The method as claimed in claim 9, wherein the destination comprises an interactive voice response (IVR) system, a user obtaining information regarding notified events by dialing into the IVR system.
